(19) United States
(12) Patent Application Publication
(10) Pub. No.: US 2026/0001316 A1
(43) Pub. Date: Jan. 1, 2026

(54) LIQUID DISCHARGE APPARATUS, LIQUID DISCHARGE METHOD, AND STORAGE MEDIUM

(71) Applicants: Shinichi Hatanaka, TOKYO (JP); Taku Satoh, KANAGAWA (JP); Kenta Takahashi, KANAGAWA (JP)

(72) Inventors: Shinichi Hatanaka, TOKYO (JP); Taku Satoh, KANAGAWA (JP); Kenta Takahashi, KANAGAWA (JP)

(73) Assignee: Ricoh Company, Ltd., Tokyo (JP)

(21) Appl. No.: 19/252,503

(22) Filed: Jun. 27, 2025

(30) Foreign Application Priority Data
Jul. 1, 2024 (JP) 2024-106444
Mar. 11, 2025 (JP) 2025-038502

(51) Int. Cl. B41J 2/045; B41J 3/407; B41J 25/00

(52) U.S. Cl. CPC B41J 2/04508; B41J 2/0451; B41J 2/04535; B41J 3/4073; B41J 25/001; B41J 2/04586

(57) ABSTRACT

A liquid discharge apparatus includes a head, a movement mechanism, and circuitry. The head has multiple nozzles to discharge a liquid onto a discharge target. The movement mechanism moves the head and the discharge target relative to each other. The circuitry controls the head and the movement mechanism based on discharge data, specifies a defective nozzle having a discharge failure, specifies a planned area onto which the liquid is to be discharged from the defective nozzle, specifies a complementing nozzle to discharge the liquid onto the planned area, determines a discharge amount of the liquid to be discharged from the complementing nozzle to the planned area based on data related to discharge characteristics, and moves the head and the discharge target relative to each other and controls the head to discharge the liquid of the discharge amount from the complementing nozzle onto the planned area.

### CROSS-REFERENCE TO RELATED APPLICATIONS

This patent application is based on and claims priority pursuant to 35 U.S.C. § 119 (a) to Japanese Patent Application Nos. 2024-106444, filed on Jul. 1, 2024, and 2025-038502, filed on Mar. 11, 2025, in the Japan Patent Office, the entire disclosure of each of which is hereby incorporated by reference herein.

### BACKGROUND

### Technical Field

The present disclosure relates to a liquid discharge apparatus, a liquid discharge method, and a storage medium storing a plurality of instructions.

### Related Art

In a liquid discharge apparatus that discharges liquid from multiple nozzles onto a discharge target, a nozzle having a discharge failure among the multiple nozzles is complemented by another nozzle.

### SUMMARY

The present disclosure described herein provides an improved liquid discharge apparatus including a head, a movement mechanism, and circuitry. The head has multiple nozzles to discharge a liquid onto a discharge target in a discharge direction based on discharge data. The movement mechanism moves the head and the discharge target relative to each other in a main scanning direction intersecting the discharge direction. The circuitry controls the head and the movement mechanism to move the head and the discharge target relative to each other and discharge the liquid based on the discharge data, specifies a defective nozzle having a discharge failure among the multiple nozzles, specifies a planned area in the discharge target onto which the liquid is to be discharged from the defective nozzle, specifies a complementing nozzle among the multiple nozzles to discharge the liquid onto the planned area, determines a discharge amount of the liquid to be discharged from the complementing nozzle to the planned area based on data related to discharge characteristics of the multiple nozzles, and moves the head and the discharge target relative to each other and controls the head to discharge the liquid of the discharge amount from the complementing nozzle onto the planned area based on the discharge data.

Further, the present disclosure described herein provides an improved liquid discharge method and a non-transitory storage medium storing a plurality of instructions which, when executed by one or more processors, causes the processors to perform a method (i.e., the liquid discharge method). The liquid discharge method includes discharging a liquid onto a discharge target from multiple nozzles of a head in a discharge direction based on discharge data, moving the head and the discharge target relative to each other in a main scanning direction intersecting the discharge direction, controlling the head and a movement mechanism to move the head and the discharge target relative to each other and discharge the liquid based on the discharge data, specifying a defective nozzle having a discharge failure among the multiple nozzles, specifying a planned area in the discharge target onto which the liquid is to be discharged from the defective nozzle, specifying a complementing nozzle among the multiple nozzles to discharge the liquid onto the planned area, determining a discharge amount of the liquid to be discharged from the complementing nozzle to the planned area based on data related to discharge characteristics of the multiple nozzles, and moving the head and the discharge target relative to each other and controlling the head to discharge the liquid of the discharge amount from the complementing nozzle onto the planned area based on the discharge data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic side view of a liquid discharge apparatus according to a first embodiment of the present disclosure;

FIG. 2 is a block diagram illustrating a hardware configuration of the liquid discharge apparatus of FIG. 1, according to the first embodiment;

FIG. 3 is a block diagram illustrating a functional configuration of a controller of the liquid discharge apparatus of FIG. 1, according to the first embodiment;

FIG. 4 is a diagram illustrating a missing image and a streak on a detection sheet due to a nozzle having a discharge failure;

FIG. 5 is a diagram illustrating a nozzle to be complemented and a complementing nozzle;

FIG. 6 is a diagram illustrating a complementation by a complementing nozzle;

FIG. 7A is a diagram illustrating dots when a complementary discharge amount is small;

FIG. 7B is a diagram illustrating dots when a complementary discharge amount is large;

FIG. 7C is a diagram illustrating dots when a complementary discharge amount is controlled by a drive voltage;

FIG. 7D is a diagram illustrating dots when a complementary discharge amount is controlled by the number of liquid droplets;

FIG. 7E is another diagram illustrating dots when a complementary discharge amount is controlled by the number of liquid droplets;

FIG. 8 is a flowchart of an operation of the liquid discharge apparatus of FIG. 1, according to the first embodiment;

FIG. 9 is a schematic side view of a liquid discharge apparatus according to a second embodiment of the present disclosure;

FIG. 10 is a block diagram illustrating a hardware configuration of the liquid discharge apparatus of FIG. 9, according to the second embodiment;

FIG. 11 is a diagram illustrating a complementation by a complementing nozzle of the liquid discharge apparatus of FIG. 9, according to the second embodiment;

FIG. 12 is a diagram illustrating a nozzle to be complemented and a complementing nozzle of the liquid discharge apparatus of FIG. 9, according to the second embodiment;

FIG. 13 is a schematic side view of a liquid discharge apparatus according to a third embodiment of the present disclosure;

FIG. 14 is a block diagram illustrating a hardware configuration of the liquid discharge apparatus of FIG. 13, according to the third embodiment; and

FIG. 15 is a flowchart of an operation of the liquid discharge apparatus of FIG. 13, according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings, like reference signs denote like elements, and redundant or overlapping descriptions thereof may be omitted as appropriate.

The embodiments described below are some examples of an image forming apparatus, an image forming method, and a storage medium storing a plurality of instructions for embodying the technical idea of the present disclosure, and embodiments of the present disclosure are not limited to the embodiments described below. Unless otherwise specified, shapes of components, relative arrangements thereof, and values of parameters described below are not intended to limit the scope of the present disclosure but are intended to exemplify the scope of the present disclosure. For example, the size and positional relationship of components illustrated in the drawings may be exaggerated for clarity of description. The arrangement is not limited to a case of direct contact, and includes a case of indirect disposition such as contact through another member.

In the drawings illustrated below, an XYZ orthogonal coordinate system may be used for indicating directions. Three axes: an X axis, a Y axis, and a Z axis in the XYZ orthogonal coordinate system are orthogonal to each other. In the XYZ orthogonal coordinate system, a direction in which the X axis extends is denoted as a first direction X, a direction in which the Y axis extends is denoted as a second direction Y, and a direction in which the Z axis extends is denoted as a third direction Z. A direction of the arrow indicating the X axis is referred to as a +X direction, and a direction opposite to the +X direction is referred to as a-X direction. A direction of the arrow indicating the Y axis is referred to as a +Y direction, and a direction opposite to the +Y direction is referred to as a −Y direction. A direction of the arrow indicating the Z axis is referred to as a +Z direction, and a direction opposite to the +Z direction is referred to as a −Z direction.

The +X direction corresponds to a sub-scanning direction 22. The +Y direction corresponds to a main scanning direction 21. The +Z direction corresponds to a lamination direction 23 (i.e., a discharge direction). These expressions that indicate specific directions are merely used to indicate a relationship such as a relative position, orientation, and direction, and the expressions may not match with an actual relationship in use. These directions are independent of the direction of gravity.

### Overall Configuration of Liquid Discharge Apparatus

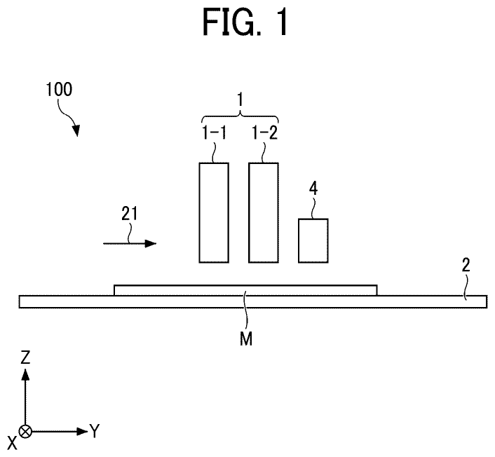

FIG. 1 is a schematic side view of a liquid discharge apparatus 100. The liquid discharge apparatus 100 includes a head 1 having multiple nozzles each of which discharges a liquid to a discharge target M in the discharge direction, a movement mechanism 2 that moves the head 1 and the discharge target M relative to each other, and a controller 3 as circuitry that controls the discharge of the liquid by the head 1 and the relative movement by the movement mechanism 2 based on discharge data related to the discharge of the liquid. In FIG. 1, the liquid discharge apparatus 100 further includes a detector 4 that detects a discharge state of the multiple nozzles included in the head 1.

In the liquid discharge apparatus 100, the movement mechanism 2 moves the head 1 and the discharge target M relative to each other in the main scanning direction 21, which is the second direction Y, and the head 1 discharges the liquid to form an image on the discharge target M. For example, the liquid discharge apparatus 100 is an inkjet printer that discharges ink, which is an example of a liquid, and applies the discharged ink to a sheet of paper, which is an example of the discharge target M, to form an image.

The liquid discharge apparatus 100 illustrated in FIG. 1 is a line-type inkjet printer in which the head 1 has multiple nozzles arrayed in the first direction X, and the movement mechanism 2 moves the head 1 and the discharge target M relative to each other only in the second direction Y. The liquid discharge apparatus 100 is a monochrome inkjet printer that discharges liquid of one color from the head 1.

In FIG. 1, the liquid discharge apparatus 100 moves the discharge target M in the main scanning direction 21, which is the second direction Y, without moving the head 1 and discharges the liquid of one color from the multiple nozzles arrayed in a row having a width equal to or larger than the width of the discharge target M in the first direction X to form a monochrome image. The liquid discharge apparatus 100 performs only one relative movement of the head 1 and the discharge target M in the main scanning direction 21. The discharge target M is not limited to the sheet of paper, and may be, for example, a sheet or a film.

For example, in the liquid discharge apparatus 100, when a nozzle has a discharge failure among the multiple nozzles, the liquid is not applied to a planned area of the discharge target M onto which the liquid is to be discharged from the nozzle having the discharge failure. The nozzle having the discharge failure may cause an abnormality such as a missing image (missing dots) on the sheet or a streak in which the missing dots are arranged linearly. For this reason, the liquid discharge apparatus may use a technique of complementing the nozzle having the discharge failure among multiple nozzles with another nozzle.

In the technique of complementing the nozzle having the discharge failure, the liquid is discharged from another nozzle different from the nozzle having the discharge failure onto a planned area of the discharge target onto which the liquid is to be discharged from the nozzle having the discharge failure. Accordingly, the planned area of the discharge target onto which the liquid is not adhered due to the discharge failure is complemented by the liquid from another nozzle. From another viewpoint, the nozzle having the discharge failure is complemented by another nozzle. The technique of complementing the nozzle having the discharge failure can prevent abnormality such as a missing image and a streak.

In a comparative example, a complementing nozzle that complements a nozzle to be complemented is selected based on a driving state of the nozzle to be complemented or a driving state of a nozzle adjacent to the nozzle to be complemented to complement the nozzle having a discharge failure with high accuracy. However, in the comparative example, the complementing nozzle is moved only for the purpose of complementation so that the liquid is discharged onto the planned area onto which the liquid is to be discharged by the nozzle to be complemented. The complementation is not an operation performed for an original purpose such as image formation in the liquid discharge apparatus. Accordingly, the relative movement of the nozzle for the purpose of complementation only is an extra operation from the viewpoint of achieving the original purpose. For example, the productivity of image formation may decrease by performing the extra operation, and the productivity of the liquid discharge apparatus may decrease.

In the liquid discharge apparatus 100, the controller 3 specifies a complementing nozzle that moves to a planned area onto which liquid is to be discharged by a nozzle to be complemented having a discharge failure (i.e., a defective nozzle) among multiple nozzles and discharges the liquid onto the planned area based on discharge data.

The discharge data is, for example, image data used for forming an image by an inkjet printer. The image data is data that defines, for example, a position to which the liquid discharged from the head 1 is to be adhered and a size of a dot formed by the liquid adhered to the position.

The relative movement based on the discharge data is an operation performed for the purpose of image formation, which is the original purpose of the liquid discharge apparatus 100. Accordingly, the complementation by the complementing nozzle that moves relative to the discharge target based on the discharge data can be performed without an extra operation for the purpose of complementation only. As a result, a decrease in productivity of the liquid discharge apparatus 100 is prevented.

In the multiple nozzles of the head 1, discharge characteristics such as a discharge amount of liquid in response to a drive voltage may be different for each nozzle due to the manufacturing variations of the head 1, and the accuracy of the complementation may be lowered according to the difference. For example, when the discharge amount of liquid discharged by the complementing nozzle in response to the drive voltage is smaller than the discharge amount of liquid discharged by the nozzle to be complemented in response to the drive voltage, the area of the discharge target onto which the liquid is not discharged due to the discharge failure may not be complemented with the liquid from the complementing nozzle with high accuracy. When the accuracy of the complementation is low, for example, a missing image and a streak are not prevented, and the quality of an image formed by the liquid discharge apparatus may be deteriorated.

The liquid discharge apparatus 100 determines a complementary discharge amount by a complementing nozzle that complements the nozzle to be complemented based on data related to the discharge characteristics of the multiple nozzles. The complementary discharge amount may be referred to simply as a discharge amount. For example, when the discharge amount of liquid in response to the drive voltage is different between the complementing nozzle and the nozzle to be complemented, the liquid discharge apparatus 100 determines the complementary discharge amount so that both are substantially equal to each other. The liquid discharge apparatus 100 determines the complementary discharge amount to complement an area on the discharge target to which the liquid is not discharged due to the discharge failure with the liquid from the complementing nozzle with high accuracy.

As described above, the nozzle having the discharge failure can be complemented with high accuracy while preventing a decrease in productivity. In addition, in the line-type liquid discharge apparatus 100 that forms an image on the discharge target M at a high speed, the nozzle having the discharge failure can be complemented with high accuracy while preventing a decrease in productivity.

The discharge failure includes a case where the liquid is not discharged from the nozzle, a case where the liquid is not discharged from the nozzle in a desired direction, a case where the liquid is not discharged from the nozzle with a desired volume, and a case where the liquid is not discharged from the nozzle at a desired speed.

The head 1 illustrated in FIG. 1 includes a first head 1-1 and a second head 1-2. The first head 1-1 and the second head 1-2 are arranged in the second direction Y. The first head 1-1 and the second head 1-2 each have multiple nozzles arrayed in the first direction X. The first head 1-1 and the second head 1-2 discharge liquid of the same color from the multiple nozzles. The same color includes a colorless liquid, i.e., a liquid having the transparency with respect to visible light.

The head 1 may include a pressure generator such as a piezoelectric element that generates pressure for discharging liquid. However, in the head 1, an energy generation source for discharging liquid is not limited to the pressure generator, and may be a thermoelectric transducer such as a thermal resistor or an electrostatic actuator including a diaphragm and opposed electrodes.

The movement mechanism 2 is a conveyance stage that is disposed below the head 1 and conveys the discharge target M placed on the conveyance stage in the main scanning direction 21. The liquid discharge apparatus 100 controls the movement mechanism 2 to move the discharge target M and controls the head 1 to discharge liquid onto the discharge target M to form a desired image on the discharge target M.

The detector 4 is a print sensor that is disposed downstream from the head 1 in the main scanning direction 21 and reads an image formed (printed) on a detection sheet by the head 1. For example, a scanner including a line sensor can be used as the print sensor. The line sensor includes multiple pixels arranged in the first direction X. The detection sheet is an example of the discharge target M to which liquid discharged from the multiple nozzles of the head 1 is adhered in order to detect a nozzle having a discharge failure.

When the detector 4 detects a nozzle having a discharge failure, the liquid discharge apparatus 100 moves the detection sheet placed on the movement mechanism 2 by the movement mechanism 2 before forming an image on the discharge target M, and discharges liquid from the multiple nozzles of the head 1. If there is no nozzle having a discharge failure, the liquid discharged from the multiple nozzles adheres to the detection sheet. An image read from the detection sheet by the print sensor does not have any abnormality such as a missing image or a streak.

On the other hand, when there is a nozzle having a discharge failure, the liquid does not adhere to an area corresponding to the position of the nozzle having a discharge failure on the detection sheet. An image read from the detection sheet by the print sensor is an image including an abnormality such as a missing image or a streak. The detector 4 outputs the image read from the detection sheet to the controller 3 as a detection result of the discharge state of the multiple nozzles. The controller 3 can specify a nozzle corresponding to an area where an abnormality such as a missing image or a streak occurs (i.e., an abnormal area) as a nozzle to be complemented, having a discharge failure based on the detection result by the detector 4.

The detector 4 is not limited to the print sensor. For example, the detector 4 may be a camera that captures an image of the gap between the head 1 and the discharge target M. The detector 4 captures an image of liquid flying through the gap when the liquid is discharged from the multiple nozzles of the head 1, using the camera. The detector 4 can output the image captured by the camera as the detection result of the discharge state of the multiple nozzles.

### Hardware Configuration of Liquid Discharge Apparatus

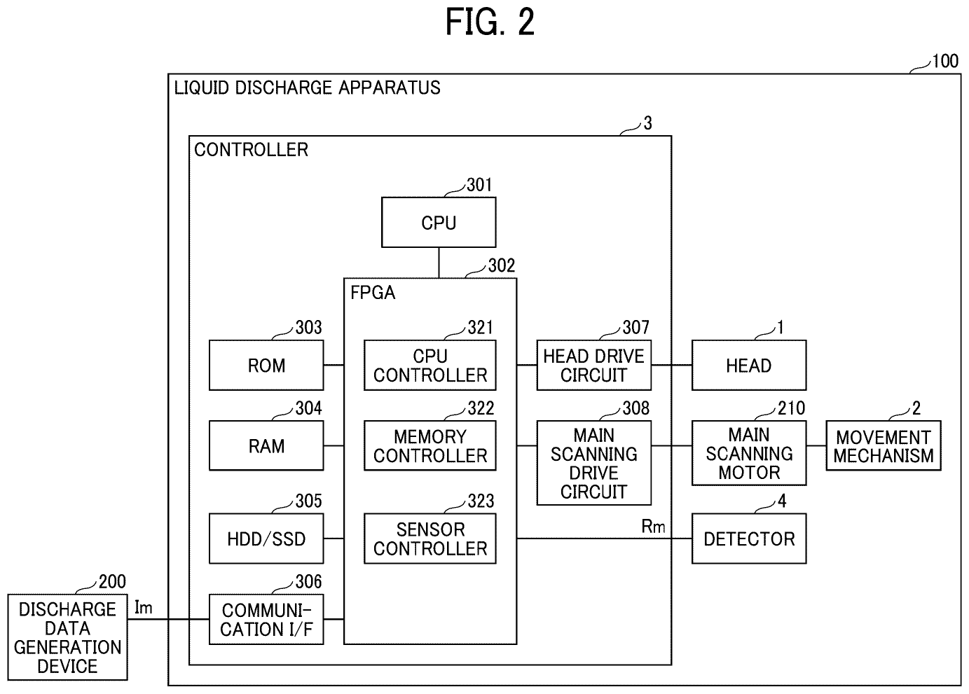

FIG. 2 is a block diagram illustrating a hardware configuration of the liquid discharge apparatus 100. The controller 3 is a board that controls the operation of each component in the liquid discharge apparatus 100. The controller 3 includes a central processing unit (CPU) 301, a field-programmable gate array (FPGA) 302, and a read-only memory (ROM) 303. The controller 3 further includes a random-access memory (RAM) 304, a hard disk drive (HDD)/solid-state drive (SSD) 305, a communication interface (I/F) 306, a head drive circuit 307, and a main scanning drive circuit 308.

The CPU 301 is a processor that controls the entire liquid discharge apparatus 100. For example, the CPU 301 uses the RAM 304 as a work area, executes processing defined by various control programs stored in the ROM 303, and outputs control commands for controlling various operations of the liquid discharge apparatus 100.

The FPGA 302 is an integrated circuit that controls various operations in the liquid discharge apparatus 100 in cooperation with the CPU 301. The FPGA 302 includes, for example, a CPU controller 321, a memory controller 322, and a sensor controller 323 as functional components (may be referred to as a functional configuration in the following description).

The CPU controller 321 is a functional configuration that communicates with the CPU 301, transmits various types of data acquired by the FPGA 302 to the CPU 301, and inputs a control command output from the CPU 301. The memory controller 322 is a functional configuration that performs memory control for the CPU 301 to access the ROM 303 and the RAM 304. The sensor controller 323 is a functional configuration that performs processing of inputting a detection result by the detector 4, for example, a read image Rm by the print sensor. The sensor controller 323 may perform processing of inputting detection results by sensors other than the detector 4.

The sensors other than the detector 4 are, for example, a main-scanning encoder sensor that detects the position of the discharge target M moved by the movement mechanism 2 and outputs data related to the position. An encoder value of the main-scanning encoder sensor is transmitted from the FPGA 302 to the CPU 301 and used to calculate the position and speed of the discharge target M. The CPU 301 generates and outputs a control command for controlling a main scanning motor 210 based on the position and speed of the discharge target M calculated from the encoder value of the main scanning encoder sensor.

The head drive circuit 307 is a drive circuit that drives the head 1 to perform a discharge operation. The main scanning drive circuit 308 is a drive circuit that drives and rotates the main scanning motor 210 so as to move the discharge target M in the main scanning direction 21 by the movement mechanism 2.

The communication I/F 306 is an interface to which an external device is connected so that the liquid discharge apparatus 100 communicates with the external device. The external device is a device or an apparatus other than the controller 3, such as a personal computer (PC). In FIG. 2, the communication I/F 306 receives, from a discharge data generation device 200, discharge date Im for the liquid discharge apparatus 100 to form an image.

The communication I/F 306 may not be directly connected to an external device. For example, the communication I/F 306 may be connected to an external device via a network, or may perform data communication with an external device via wireless connection.

The head drive circuit 307 controlled by the CPU 301 and the FPGA 302 drives the head 1 to discharge liquid. The main scanning drive circuit 308 controlled by the CPU 301 and the FPGA 302 drives and rotates the main scanning motor 210. The movement mechanism 2 moves the discharge target M by the rotation drive of the main scanning motor 210.

The hardware configuration of the liquid discharge apparatus 100 illustrated in FIG. 2 is an example. The liquid discharge apparatus 100 may include components other than the components illustrated in FIG. 2.

### Functional Configuration of Controller

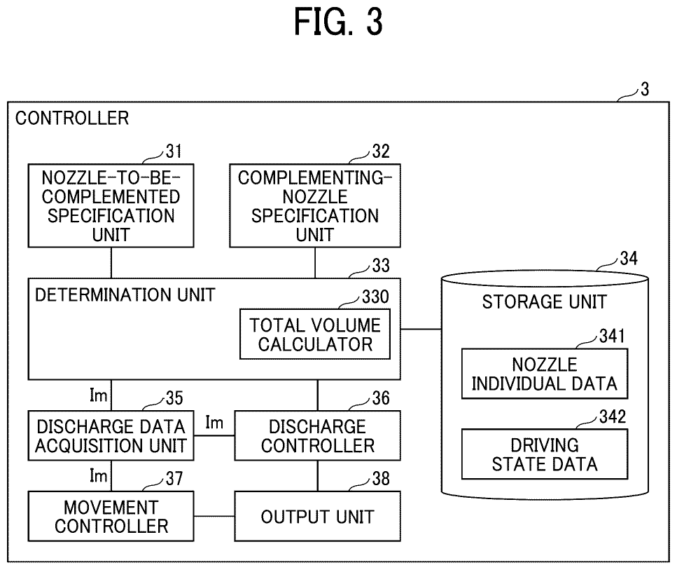

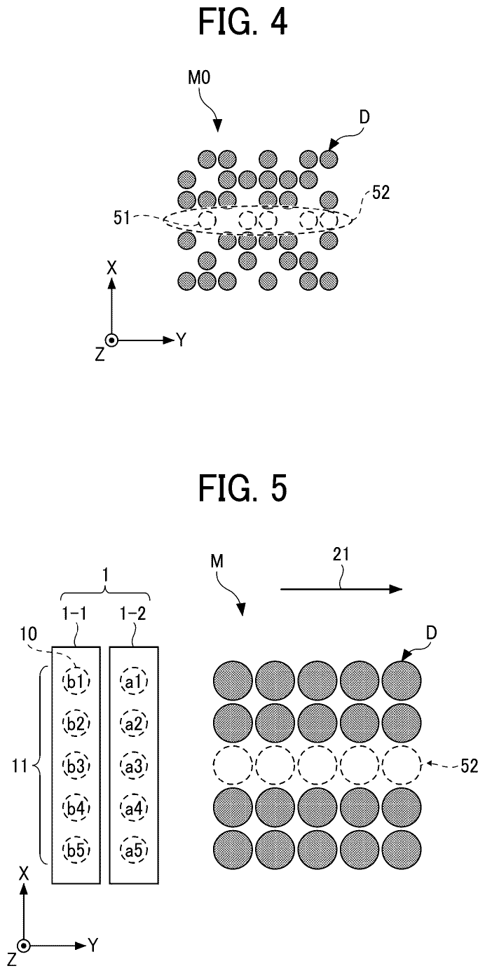

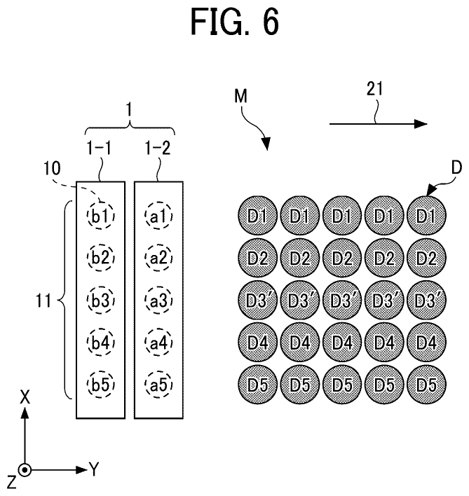

The functional configuration of the controller 3 will be described below with reference to FIGS. 3 to 6 and 7A to 7E. FIG. 3 is a block diagram illustrating a functional configuration of the controller 3 of the liquid discharge apparatus 100. FIG. 4 is a diagram illustrating a missing image and a streak on a detection sheet M0 due to a nozzle having a discharge failure. FIG. 5 is a diagram illustrating a nozzle to be complemented and a complementing nozzle. FIG. 6 is a diagram illustrating a complementation by a complementing nozzle.

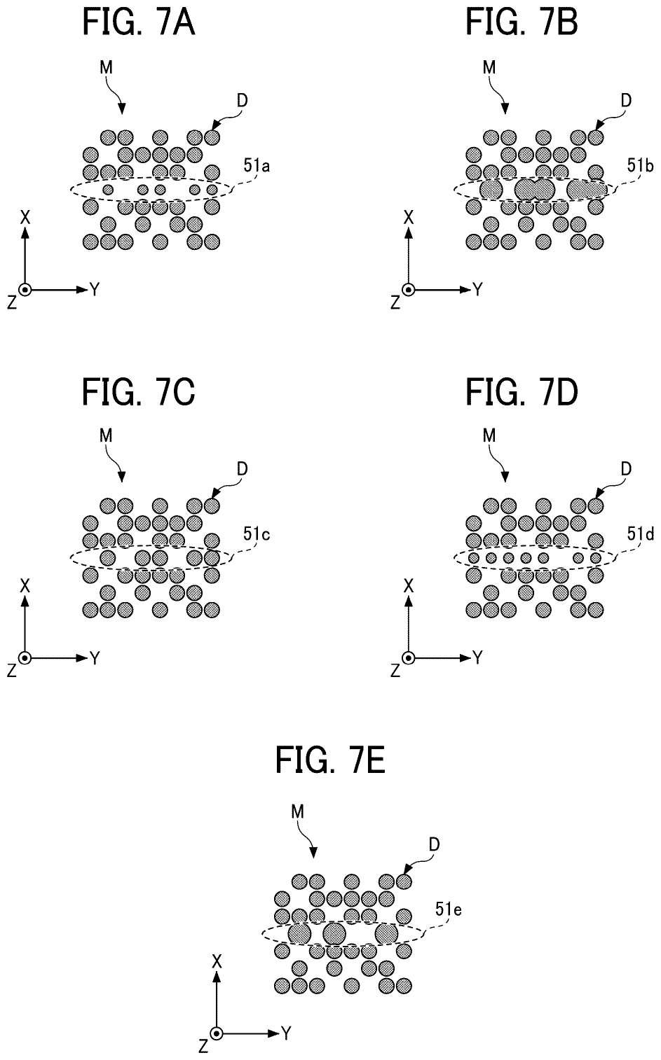

FIG. 7A is a diagram illustrating dots when a complementary discharge amount is small. FIG. 7B is a diagram illustrating dots when a complementary discharge amount is large. FIG. 7C is a diagram illustrating dots when a complementary discharge amount is controlled by a drive voltage. FIG. 7D is a diagram illustrating dots when a complementary discharge amount is controlled by the number of liquid droplets. FIG. 7E is another diagram illustrating dots when a complementary discharge amount is controlled by the number of liquid droplets.

As illustrated in FIG. 3, the controller 3 includes a nozzle-to-be-complemented specification unit 31, a complementing-nozzle specification unit 32, a determination unit 33, a storage unit 34, a discharge data acquisition unit 35, a discharge controller 36, a movement controller 37, and an output unit 38.

The functions of the nozzle-to-be-complemented specification unit 31, the complementing-nozzle specification unit 32, the determination unit 33, the discharge controller 36, and the movement controller 37 are implemented by the CPU 301 executing processing defined by programs stored in the ROM 303. The functions of the discharge data acquisition unit 35 and the output unit 38 are implemented by the communication I/F 306 or by the CPU 301 executing processing defined by programs stored in the ROM 303. The function of the storage unit 34 is implemented by, for example, the HDD/SSD 305. However, some of the functions of the controller 3 may be implemented by an external device other than the controller 3, or may be distributed between the controller 3 and the external device to implement the functions. Examples of the external device include a PC and a server.

The nozzle-to-be-complemented specification unit 31 is a functional configuration that specifies a nozzle to be complemented having a discharge failure based on the discharge states of the multiple nozzles detected by the detector 4.

FIG. 4 illustrates a missing image and a streak on the detection sheet M0 due to a nozzle having a discharge failure. An area on the detection sheet M0 is enlarged in FIG. 4. Dots D indicated by black circles are dots formed by liquid which is discharged from the head 1 and adhered to the detection sheet M0. The dots D arranged in the first direction X are formed by the liquid discharged from the multiple nozzles arrayed in the first direction X. The movement mechanism 2 moves the detection sheet M0 in the second direction Y, and the head 1 discharges the liquid. As a result, the dots D arranged in the second direction Y are formed by the liquid discharged from each of the multiple nozzles.

A missing portion 51 is an area to which liquid is not adhered on the detection sheet M0 because the liquid is not discharged from a nozzle having a discharge failure. A streak 52 is formed of missing portions 51 arranged in the second direction Y along with the movement of the detection sheet M0 in the second direction Y by the movement mechanism 2. In other words, the area to which liquid is not adhered extends in the second direction Y to form the streak 52. In FIG. 4, the streak 52 includes the missing portions 51. However, the missing portion 51 is not only a portion included in the streak 52, but also an area where a dot is locally missing in the image corresponds to the missing portion 51.

The detector 4 outputs, to the controller 3, the read image Rm of the detection sheet M0 in which the missing portion 51 of the image and the streak 52 have occurred, for example, as illustrated in FIG. 4. The nozzle-to-be-complemented specification unit 31 specifies and extracts, by image processing, an abnormal area (i.e., the planned area) including a missing image or a streak in the read image Rm input from the detector 4.

The nozzle-to-be-complemented specification unit 31 specifies a nozzle corresponding to the abnormal area, i.e., a nozzle which is planned to discharge liquid to the abnormal area, among the multiple nozzles of the head 1, as a nozzle to be complemented (i.e., the defective nozzle), having a discharge failure. The nozzle-to-be-complemented specification unit 31 passes a specification result to the determination unit 33.

The liquid discharge apparatus 100 includes the nozzle-to-be-complemented specification unit 31, and thus can easily and accurately specify the nozzle to be complemented. However, the liquid discharge apparatus 100 may specify the nozzle to be complemented, for example, by inputting data of the nozzle to be complemented specified by a device different from the liquid discharge apparatus 100, without the nozzle-to-be-complemented specification unit 31.

The complementing-nozzle specification unit 32 is a functional configuration that specifies a complementing nozzle that moves to a planned area onto which liquid is to be discharged by a nozzle to be complemented having a discharge failure among the multiple nozzles of the head 1 and discharges the liquid onto the planned area based on the discharge data Im.

FIG. 5 illustrates a nozzle a3 as a nozzle to be complemented and a nozzle b3 as a complementing nozzle. In FIG. 5, the nozzle a3 is the nozzle to be complemented having a discharge failure. The streak 52 is an area corresponding to the nozzle a3 on the discharge target M.

In the head 1 illustrated in FIG. 5, each of the first head 1-1 and the second head 1-2 includes multiple nozzles 10 arrayed in the first direction X. From another viewpoint, the head 1 has two nozzle arrays 11 each including the multiple nozzles 10 arrayed in the first direction X. The two nozzle arrays 11 are arrayed in the second direction Y. The nozzle b3 is the complementing nozzle disposed upstream from the nozzle a3 in the main scanning direction 21 to complement the nozzle a3. The nozzle a3, the nozzle b3, and other nozzles are collectively referred to as the nozzles 10. The nozzle array of the first head 1-1 and the nozzle array of the second head 1-2 are collectively referred to as the nozzle arrays 11 unless distinguished. The complementing-nozzle specification unit 32 specifies the nozzle b3 disposed upstream from the nozzle a3 in the main scanning direction 21 as the complementing nozzle.

FIG. 6 illustrates the complementation performed by a complementing nozzle from a viewpoint different from that of FIG. 5. In FIG. 6, the first head 1-1 includes five nozzles 10 including nozzles b1 to b5. The second head 1-2 includes five nozzles 10 including nozzles a1 to a5. Dots D1 are formed by liquid discharged from the nozzle a1. Dots D2 are formed by liquid discharged from the nozzle a2. Dots D3′ are formed by liquid discharged from the nozzle b3. Dots D4 are formed by liquid discharged from the nozzle a4. Dots D5 are formed by liquid discharged from the nozzle a5.

The nozzle a3 is a nozzle to be complemented having a discharge failure. The liquid discharge apparatus 100 does not discharge liquid from the nozzle a3 to an area corresponding to the nozzle a3. As described above, the complementing-nozzle specification unit 32 specifies the nozzle b3 disposed upstream from the nozzle a3 in the main scanning direction 21 as the complementing nozzle. The liquid discharge apparatus 100 discharges liquid from the nozzle b3 to apply the liquid to the area corresponding to the nozzle a3. Thus, the nozzle a3 is complemented by the nozzle b3.

The nozzle b3 illustrated in FIG. 5 is disposed upstream from the nozzle a3 in the main scanning direction 21, and thus, the liquid can be discharged to the area including the streak 52 without the relative movement for the purpose of complementation only. The area including the streak 52 is an area onto which liquid is planned to be discharged by the nozzle a3 (i.e., the planned area). The nozzle b3 illustrated in FIG. 6 is disposed upstream from the nozzle a3 in the main scanning direction 21, and thus liquid can be discharged to the planned area onto which liquid is to be discharged by the nozzle a3 without the relative movement for the purpose of complementation only. The liquid discharge apparatus 100 performs complementation during image formation without an extra relative movement of the complementing nozzle for the purpose of complementation only by using the nozzle b3 illustrated in FIGS. 5 and 6. Accordingly, the liquid discharge apparatus 100 can perform complementation while preventing a decrease in productivity.

In FIG. 3, the determination unit 33 is a functional configuration that determines a complementary discharge amount by a complementing nozzle that complements a nozzle to be complemented based on the data related to the discharge characteristics of the multiple nozzles. When the discharge amount of liquid in response to the drive voltage is different between the complementing nozzle and the nozzle to be complemented, the determination unit 33 determines the complementary discharge amount by the complementing nozzle so that both discharge amounts are equal to each other.

The expression “both discharge amounts are equal to each other” means not only that both discharge amounts completely match each other, but also that there is a difference of 1/10 or less between both discharge amounts. For example, when the difference between the discharge amount of liquid discharged by the nozzle to be complemented and the discharge amount of liquid discharged by the complementing nozzle in response to the same drive voltage is 1/10 or less of the discharge amount of liquid discharged by the nozzle to be complemented in response to the same drive voltage, it can be considered that the discharge amount of liquid discharged by the nozzle to be complemented and the discharge amount of liquid discharged by the complementing nozzle are equal to each other. The meaning of “equal to each other” is the same in the following description in that there may be a certain allowable difference.

In FIG. 3, the storage unit 34 stores nozzle individual data 341. The nozzle individual data 341 is predetermined data indicating a relationship between the multiple nozzles of the head 1 and a unit discharge volume. The unit discharge volume is a volume of liquid per discharge in response to application of a unit drive voltage. From another viewpoint, the “data related to the discharge characteristics of the multiple nozzles” used by the determination unit 33 includes the nozzle individual data 341.

Table 1 illustrates an example of the nozzle individual data 341. The nozzle individual data 341 stores identification numbers of the multiple nozzles of the head 1 and unit discharge volumes in association with each other. The determination unit 33 acquires data related to the unit discharge volume of the nozzle to be complemented based on the identification number corresponding to the nozzle to be complemented with reference to the nozzle individual data 341. The determination unit 33 acquires data related to the unit discharge volume of the complementing nozzle based on the identification number corresponding to the complementing nozzle with reference to the nozzle individual data 341.

TABLE 1

| Nozzle Identification Number | Unit Discharge Volume |
|---|---|
| N1 | Q1 |
| N2 | Q2 |
| N3 | Q3 |
| . | . |
| . | . |
| . | . |

The determination unit 33 illustrated in FIG. 3 includes a total volume calculator 330. The total volume calculator 330 is a functional configuration that calculates the total volume of liquid discharged by the nozzle to be complemented and the complementing nozzle in a period of one relative movement of the head 1 and the discharge target M in the main scanning direction 21.

The total volume calculator 330 calculates the total volume of liquid to be discharged by the nozzle to be complemented and the total volume of liquid to be discharged by the complementing nozzle. For example, the total volume calculator 330 acquires data of the number of times of discharge by the nozzle to be complemented based on the discharge data Im acquired from the discharge data generation device 200 via the discharge data acquisition unit 35. The data of the number of times of discharge indicates how many times the nozzle to be complemented is planned to discharge liquid during a period of one relative movement in the main scanning direction 21. The total volume calculator 330 multiplies the number of times of discharge by the unit discharge volume of the nozzle to be complemented to calculate the total volume of liquid discharged by the nozzle to be complemented. In addition, the total volume calculator 330 acquires data of the number of times of discharge by the complementing nozzle based on the discharge data Im. The data of the number of times of discharge indicates how many times the complementing nozzle is planned to discharge liquid during a period of one relative movement in the main scanning direction 21. The total volume calculator 330 multiplies the number of times of discharge by the unit discharge volume of the complementing nozzle to calculate the total volume of liquid discharged by the complementing nozzle.

The determination unit 33 determines the complementary discharge amount so as to equalize the total volume of liquid discharged from the nozzle to be complemented and the total volume of liquid discharged from the complementing nozzle with each other in a period of one relative movement in the main scanning direction 21. Thus, the determination unit 33 can determine the complementary discharge amount so that the discharge amounts are uniform in a large number of times of discharge. As a result, in the liquid discharge apparatus 100, the accuracy of complementation can be increased as compared with a case where the complementary discharge amount is determined so that the discharge amount is uniform in a small number of times of discharge.

On the other hand, the amount of liquid discharged from the nozzle in response to the drive voltage may change according to a continuous driving state such as a time during which the nozzle continuously discharges liquid or a cycle of the continuous discharge. For example, in a case where the same drive voltage is applied, the discharge amount of liquid may become smaller when the liquid is continuously discharged for longer time, or the discharge amount of liquid may become smaller when the cycle of the continuous discharge is shorter (in other words, when the repetition frequency of the continuous discharge is higher).

Further, the amount of liquid discharged from the nozzle in response to the drive voltage may also change depending on a vicinity driving state of the nozzle positioned in the vicinity of the nozzle that discharges liquid (i.e., a discharge nozzle of the multiple nozzles). For example, when a nozzle and an adjacent nozzle adjacent to the nozzle discharge liquid at substantially the same timing, the discharge amount of liquid may decrease or increase compared to when the adjacent nozzle does not discharge the liquid at substantially the same timing. The nozzle in the vicinity of the nozzle that discharges liquid includes not only one adjacent nozzle but also multiple nozzles positioned adjacent to the nozzle continuously or intermittently.

In FIG. 3, the storage unit 34 stores driving state data 342. The driving state data 342 defines (predefines) a relationship between each of the continuous driving state and the vicinity driving state and the complementary discharge amount in advance. From another viewpoint, the “data related to the discharge characteristics of the multiple nozzles” used by the determination unit 33 includes the driving state data 342.

Table 2 illustrates an example of the driving state data 342. The driving state data 342 stores a combination of “a continuous driving time of the nozzle that discharges liquid” as the continuous driving state and “a driving pattern of the nozzle in the vicinity of the nozzle that discharges the liquid” as the vicinity driving state, and a discharge coefficient by which a discharge amount is multiplied, in association with each other.

TABLE 2

| Continuous | Vicinity | Discharge |
|---|---|---|
| Driving State | Driving State | Coefficient |
| t1 | C1 | K11 |
| t2 | C1 | K21 |
| t3 | C1 | K31 |
| . | . | . |
| . | . | . |
| . | . | . |
| t1 | C2 | K12 |
| t2 | C2 | K22 |
| t3 | C2 | K32 |
| . | . | . |
| . | . | . |
| . | . | . |

The determination unit 33 acquires data related to the continuous driving state and the vicinity driving state of the nozzle to be complemented based on the discharge data Im. The determination unit 33 acquires the discharge coefficient of the nozzle to be complemented based on the continuous driving state and the vicinity driving state of the nozzle to be complemented with reference to the driving state data 342. The determination unit 33 multiplies the total volume of liquid to be discharged by the nozzle to be complemented, which is calculated by the total volume calculator 330, by the discharge coefficient to correct the calculated value of the total volume.

The determination unit 33 acquires data related to the continuous driving state and the vicinity driving state of the complementing nozzle based on the discharge data Im. The determination unit 33 acquires the discharge coefficient of the complementing nozzle based on the continuous driving state and the vicinity driving state of the complementing nozzle with reference to the driving state data 342. The determination unit 33 multiplies the total volume of liquid to be discharged by the complementing nozzle, which is calculated by the total volume calculator 330, by the discharge coefficient to correct the calculated value of the total volume.

The determination unit 33 determines the complementary discharge amount by the complementing nozzle so that the total volume of liquid after the correction by the nozzle to be complemented and the total volume of liquid after the correction by the complementing nozzle are equal to each other. As described above, the determination unit 33 corrects the influence of the continuous driving state and the vicinity driving state of each of the nozzle to be complemented and the complementing nozzle on the calculated value of the total volume to determine the complementary discharge amount with high accuracy.

The driving state data 342 may be data of at least one of the continuous driving state or the vicinity driving state. The determination unit 33 may determine the complementary discharge amount using the driving state data 342 of at least one of the nozzle to be complemented or the complementing nozzle. The determination unit 33 may determine the complementary discharge amount by using only the nozzle individual data 341 without using the driving state data 342. When the determination unit 33 uses only the nozzle individual data 341, the storage unit 34 may store only the nozzle individual data 341 without storing the driving state data 342.

In FIG. 3, the discharge controller 36 is a functional configuration that controls discharge of liquid by the head 1. The discharge controller 36 drives the head 1 to discharge liquid based on the discharge data Im to control the discharge of the liquid by the head 1. The discharge controller 36 controls the drive voltage applied to the head 1 so that the complementing nozzle discharges the liquid of the complementary discharge amount determined by the determination unit 33.

FIG. 7A illustrates dots when a complementary discharge amount by the complementing nozzle is small. A complemented area 51a is a planned area onto which liquid is to be discharged by the nozzle to be complemented. In FIG. 7A, liquid has been discharged onto the complemented area 51a by the complementing nozzle. In FIG. 7A, the complementary discharge amount by the complementing nozzle is smaller than the amount of liquid to be discharged by the nozzle to be complemented. As a result, the size of dot formed of the liquid discharged by the complementing nozzle is smaller than the size of the dot in the area other than the planned area onto which liquid is to be discharged by the nozzle to be complemented. Such control of the discharge of the liquid reduces the accuracy of complementation. For example, the image density in the planned area onto which liquid is to be discharged by the nozzle to be complemented may be lower than the image density in the area other than the planned area, and thus the quality of the image formed on the discharge target M may be deteriorated.

FIG. 7B illustrates dots when a complementary discharge amount by the complementing nozzle is large. A complemented area 51b is a planned area onto which liquid is to be discharged by the nozzle to be complemented. In FIG. 7B, liquid has been discharged onto the complemented area 51b by the complementing nozzle. In FIG. 7B, the complementary discharge amount by the complementing nozzle is larger than the amount of liquid to be discharged by the nozzle to be complemented. As a result, the size of dot formed of the liquid discharged by the complementing nozzle is larger than the size of the dot in the area other than the planned area onto which liquid is to be discharged by the nozzle to be complemented. Such control of the discharge of the liquid reduces the accuracy of complementation. For example, the image density in the planned area onto which liquid is to be discharged by the nozzle to be complemented may be higher than the image density in the area other than the planned area, and thus the quality of the image formed on the discharge target M may be deteriorated.

FIG. 7C illustrates dots when the drive voltage applied to the head 1 is controlled so that the complementing nozzle discharges the liquid of the complementary discharge amount determined by the determination unit 33. A complemented area 51c is a planned area onto which liquid is to be discharged by the nozzle to be complemented. In FIG. 7C, liquid has been discharged onto the complemented area 51c by the complementing nozzle. In FIG. 7C, the complementary discharge amount by the complementing nozzle is equal to the amount of liquid to be discharged by the nozzle to be complemented. As a result, the size of dot formed of the liquid discharged by the complementing nozzle is equal to the size of the dot in the area other than the planned area onto which liquid is to be discharged by the nozzle to be complemented. Such control of the discharge of the liquid increases the accuracy of complementation.

As described above, the liquid discharge apparatus 100 controls the drive voltage applied to the head 1 by the discharge controller 36 so that the complementing nozzle discharges the liquid of the complementary discharge amount determined by the determination unit 33. Accordingly, the complementation can be performed with high accuracy.

A control method by the discharge controller 36 for the complementing nozzle to discharge the liquid of the complementary discharge amount determined by the determination unit 33 is not limited to the control of the drive voltage. For example, the discharge controller 36 controls the number of liquid droplets discharged from the complementing nozzle per unit time so as to control the complementing nozzle to discharge the liquid of the complementary discharge amount determined by the determination unit 33.

In other words, the discharge controller 36 can control at least one of the drive voltage applied to the head 1 or the number of liquid droplets discharged from the complementing nozzle per unit time so that the complementing nozzle discharges the liquid of the complementary discharge amount determined by the determination unit 33.

FIG. 7D illustrates an example of dots when a complementary discharge amount is controlled by the number of liquid droplets. In FIG. 7D, the complementary discharge amount per one discharge by the complementing nozzle is smaller than the amount of liquid per one discharge to be discharged by the nozzle to be complemented. Accordingly, the size of the dot formed by the complementing nozzle is smaller than the size of the dot in the area other than the planned area onto which the liquid is to be discharged by the nozzle to be complemented. The discharge controller 36 increases the number of liquid droplets to be discharged so as to complement the size of the dot, which is small in FIG. 7D, with the number of liquid droplets. The liquid droplet is an example of a liquid. The liquid discharged from the nozzle forms a liquid droplet. In FIG. 7D, the number of liquid droplets discharged is increased. As a result, the amount of liquid adhered to the discharge target M is uniform between a complemented area 51d onto which liquid is to be discharged by the nozzle to be complemented and the area other than the complemented area 51d. As a result, the accuracy of complementation is increased. For example, the image density in the complemented area 51d is prevented from being lower than the image density in the area other than the complemented area 51d.

FIG. 7E illustrates another example of dots when a complementary discharge amount is controlled by the number of liquid droplets. In FIG. 7E, the complementary discharge amount per one discharge by the complementing nozzle is larger than the amount of liquid per one discharge to be discharged by the nozzle to be complemented. Accordingly, the size of the dot formed by the complementing nozzle is larger than the size of the dot in the area other than the planned area onto which the liquid is to be discharged by the nozzle to be complemented. The discharge controller 36 decreases the number of liquid droplets to be discharged so as to complement the size of the dot, which is large in FIG. 7E, with the number of liquid droplets. In FIG. 7E, the number of liquid droplets discharged is decreased. As a result, the amount of liquid adhered to the discharge target is uniform between a complemented area 51e onto which liquid is to be discharged by the nozzle to be complemented and the area other than the complemented area 51e. Such control of the discharge of the liquid increases the accuracy of complementation. For example, the image density in the complemented area 51e is prevented from being higher than the image density in the area other than the complemented area 51e.

In FIG. 3, the movement controller 37 is a functional configuration that controls the relative movement of the head 1 and the discharge target M by the movement mechanism 2. For example, the movement controller 37 drives and rotates the main scanning motor 210 based on the discharge data Im to control the relative movement of the head 1 and the discharge target M by the movement mechanism 2.

The output unit 38 is a functional configuration that controls communication between the controller 3 and devices other than the controller 3 to output a drive signal or a control signal to the devices other than the controller 3. The devices other than the controller 3 include the head 1 and the main scanning motor 210. The discharge controller 36 outputs the control signal for discharging liquid to the head 1 via the output unit 38. The movement controller 37 outputs the control signal for driving and rotating the main scanning motor 210 via the output unit 38.

### Operation of Liquid Discharge Apparatus

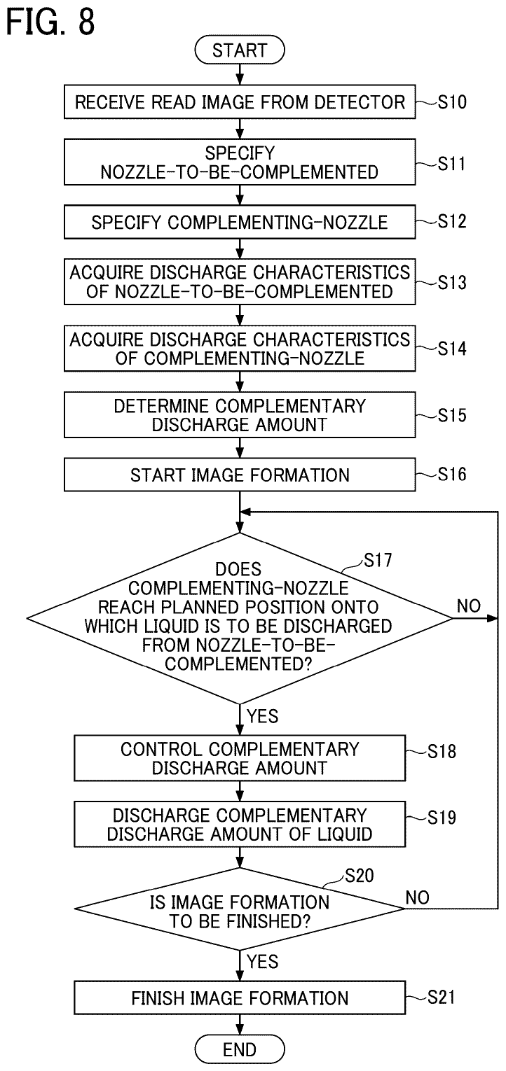

FIG. 8 is a flowchart of an operation of the liquid discharge apparatus 100. For example, in step S10, the liquid discharge apparatus 100 receives the read image Rm, which is a result of detecting the discharge state of the multiple nozzles, from the detector 4 as a start condition to start the operation of FIG. 8. However, the start condition of the operation of FIG. 8 is not limited to the above condition. For example, the start condition of the operation in FIG. 8 may be that the liquid discharge apparatus 100 receives an operation input for starting the operation by an operator of the liquid discharge apparatus 100.

In step S11, the liquid discharge apparatus 100 acquires, from the detector 4, a detection result of the discharge state of the multiple nozzles of the head 1 by the detector 4. The liquid discharge apparatus 100 specifies a nozzle to be complemented based on the detection result by the detector 4 with the nozzle-to-be-complemented specification unit 31. The nozzle-to-be-complemented specification unit 31 transmits data related to the specified nozzle to be complemented to the determination unit 33.

In step S12, the liquid discharge apparatus 100 specifies a complementing nozzle with the complementing-nozzle specification unit 32. The complementing-nozzle specification unit 32 transmits data related to the specified complementing nozzle to the determination unit 33. The step S12 may be executed before the step S11. Alternatively, the step S11 and the step S12 may be executed in parallel.

In step S13, the liquid discharge apparatus 100 acquires data related to the discharge characteristics of the nozzle to be complemented with the determination unit 33. For example, the determination unit 33 acquires data related to the unit discharge volume of the nozzle to be complemented based on identification data (i.e., the identification number) of the specified nozzle to be complemented with reference to the nozzle individual data 341 stored in the storage unit 34. The determination unit 33 acquires the discharge coefficient of the nozzle to be complemented based on the identification data of the nozzle to be complemented with reference to the driving state data 342 stored in the storage unit 34.

In step S14, the liquid discharge apparatus 100 acquires data related to the discharge characteristics of the complementing nozzle with the determination unit 33. For example, the determination unit 33 acquires data related to the unit discharge volume of the complementing nozzle based on the identification data of the specified complementing nozzle with reference to the nozzle individual data 341. The determination unit 33 acquires the discharge coefficient of the complementing nozzle based on the identification data (i.e., the identification number) of the complementing nozzle with reference to the driving state data 342 stored in the storage unit 34. The step S14 may be executed before the step S13. Alternatively, the step S13 and the step S14 may be executed in parallel.

In step S15, the liquid discharge apparatus 100 determines the complementary discharge amount of the liquid to be discharged by the complementing nozzle with the determination unit 33. For example, the determination unit 33 calculates the total volume of the liquid to be discharged by the nozzle to be complemented in a period of one relative movement of the head 1 and the discharge target M in the main scanning direction 21, based on the data related to the unit discharge volume of the nozzle to be complemented, with the total volume calculator 330. The determination unit 33 multiplies the calculated value of the total volume calculated by the total volume calculator 330 by the discharge coefficient of the nozzle to be complemented to correct the calculated value of the total volume of liquid to be discharged by the nozzle to be complemented. The determination unit 33 calculates the total volume of the liquid to be discharged by the complementing nozzle in a period of one relative movement of the head 1 and the discharge target M in the main scanning direction 21, based on the data related to the unit discharge volume of the complementing nozzle, with the total volume calculator 330. The determination unit 33 multiplies the calculated value of the total volume calculated by the total volume calculator 330 by the discharge coefficient of the complementing nozzle to correct the calculated value of the total volume of liquid to be discharged by the complementing nozzle.

The determination unit 33 determines the complementary discharge amount by the complementing nozzle so that the total volume of liquid after the correction by the nozzle to be complemented and the total volume of liquid after the correction by the complementing nozzle are equal to each other. The determination unit 33 transmits data related to the determined complementary discharge amount to the discharge controller 36.

In step S16, the liquid discharge apparatus 100 starts image formation. For example, the liquid discharge apparatus 100 controls the discharge of the liquid by the head 1 and the relative movement by the movement mechanism 2 based on the discharge data Im with the discharge controller 36 and the movement controller 37 to form an image on the discharge target M. After that, the liquid discharge apparatus 100 continuously performs image formation until the liquid discharge apparatus 100 finishes the image formation in step S21. The start of the image formation is not limited to after the execution of the step S15, and may be performed at any timing between the step S11 and the step S15 as long as the image formation is performed in time for the operation of the step S17.

In step S17, the liquid discharge apparatus 100 determines whether the head 1 has reached a position at which the complementing nozzle can discharge liquid to the planned area of the discharge target M onto which the liquid is to be discharged by the nozzle to be complemented, with the controller 3. In step S17, when the controller 3 determines that the head 1 has not reached the position (No in step S17), the liquid discharge apparatus 100 repeatedly performs the operation of step S17 until the controller 3 determines that the head 1 has reached the position.

On the other hand, in step S17, when the controller 3 determines that the head 1 has reached the position (Yes in step S17), in step S18, the liquid discharge apparatus 100 controls the drive voltage applied to the head 1 by the discharge controller 36 such that the complementing nozzle discharges the liquid of the complementary discharge amount determined by the determination unit 33. After the complementing nozzle is ready to discharge the liquid of the complementary discharge amount, the discharge controller 36 stops controlling the drive voltage.

In step S19, the liquid discharge apparatus 100 controls the head 1 with the discharge controller 36 such that the complementing nozzle discharges the liquid of the complementary discharge amount. The head 1 discharges the liquid of the complementary discharge amount, and thus the liquid discharge apparatus 100 can complement the nozzle to be complemented with the complementing nozzle.

In step S20, the liquid discharge apparatus 100 causes the controller 3 to determine whether the image formation is to be finished. For example, the controller 3 determines to finish the image formation when the formation of the entire image corresponding to the discharge data Im is ended. In step S20, when the controller 3 determines that the image formation is not finished (No in step S20), the operation of the liquid discharge apparatus 100 returns to step S17, and the liquid discharge apparatus 100 repeatedly performs the operation of step S17 and the subsequent operations until the controller 3 determines that the image formation is to be finished in step S20.

On the other hand, in step S20, when the controller 3 determines that the image formation is to be finished (Yes in step S20), in step S21, the liquid discharge apparatus 100 stops the control of the discharge by the head 1 and the control of the relative movement of the head 1 and the discharge target M by the movement mechanism 2 to finish the image formation. Thus, the head 1 and the movement mechanism 2 stop the operation.

As described above, the liquid discharge apparatus 100 can complement the nozzle to be complemented with the complementing nozzle.

A liquid discharge apparatus 100a is described below. In the following description, names and reference signs similar to those described above denote like or equivalent components, and a detailed description thereof may be omitted as appropriate. The same applies to a liquid discharge apparatus described later.

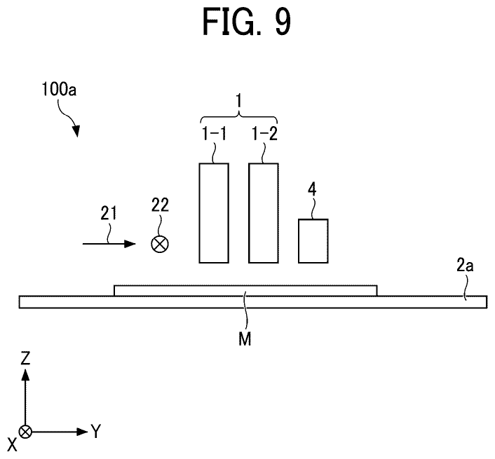

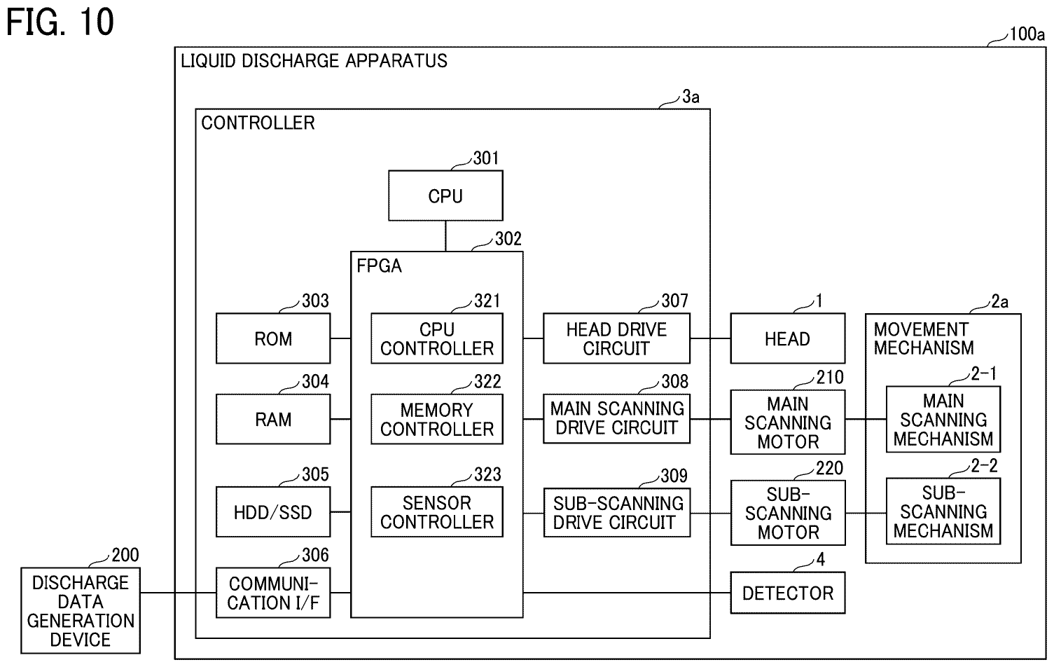

A description is given below of a configuration of the liquid discharge apparatus 100a with reference to FIGS. 9 and 10. FIG. 9 is a schematic side view of the liquid discharge apparatus 100a. FIG. 10 is a block diagram illustrating a hardware configuration of the liquid discharge apparatus 100a. The liquid discharge apparatus 100a is different from the liquid discharge apparatus 100 in that a movement mechanism 2a moves the head 1 and the discharge target M relative to each other in each of the first direction X and the second direction Y.

The liquid discharge apparatus 100a illustrated in FIG. 9 moves the head 1 and the discharge target M relative to each other in each of the sub-scanning direction 22, which is the first direction X, and the main scanning direction 21, which is the second direction Y, by the movement mechanism 2a. For example, the liquid discharge apparatus 100a illustrated in FIG. 9 is a serial-type inkjet printer. The liquid discharge apparatus 100a performs multiple relative movements of the head 1 and the discharge target M in the main scanning direction 21.

As illustrated in FIGS. 9 and 10, the liquid discharge apparatus 100a is different from the liquid discharge apparatus 100 in that the liquid discharge apparatus 100a includes the movement mechanism 2a, a controller 3a, and a sub-scanning motor 220. The movement mechanism 2a includes a main scanning mechanism 2-1 and a sub-scanning mechanism 2-2. The controller 3a includes a sub-scanning drive circuit 309.

The main scanning drive circuit 308 is an electric circuit that drives and rotates the main scanning motor 210 to move the head 1 in the main scanning direction 21 by the main scanning mechanism 2-1. The sub-scanning drive circuit 309 is an electric circuit that drives the sub-scanning motor 220 to move the discharge target M in the sub-scanning direction 22 by the sub-scanning mechanism 2-2. The liquid discharge apparatus 100a moves the head 1 and the discharge target M relative to each other in each of the main scanning direction 21 and the sub-scanning direction 22 to form an image. The liquid discharge apparatus 100a may move the head 1 in the −Y direction to reciprocate the head 1 in the second direction Y to form an image. When the head 1 is reciprocated, each of the +Y direction and the −Y direction corresponds to the main scanning direction 21.

The liquid discharge apparatus 100a may include the main scanning encoder sensor that detects the position of the head 1 moved by the main scanning mechanism 2-1 and outputs data related to the position. The liquid discharge apparatus 100a may include a sub-scanning encoder sensor that detects the position of the discharge target M moved by the sub-scanning mechanism 2-2 and outputs data related to the position.

The encoder value of the main-scanning encoder sensor is sent from FPGA 302 to CPU 301 and used to calculate the position and speed of the head 1. An encoder value of the sub-scanning encoder sensor is sent from the FPGA 302 to the CPU 301 and used to calculate the position and speed of the discharge target M. The CPU 301 generates and outputs a control command for controlling the main scanning motor 210 based on the position and speed of the discharge target M calculated from the encoder value of the sub-scanning encoder sensor. The CPU 301 generates and outputs a control command for controlling the sub-scanning motor 220 based on the position and speed of the head 1 calculated from the encoder value of the main scanning encoder sensor.

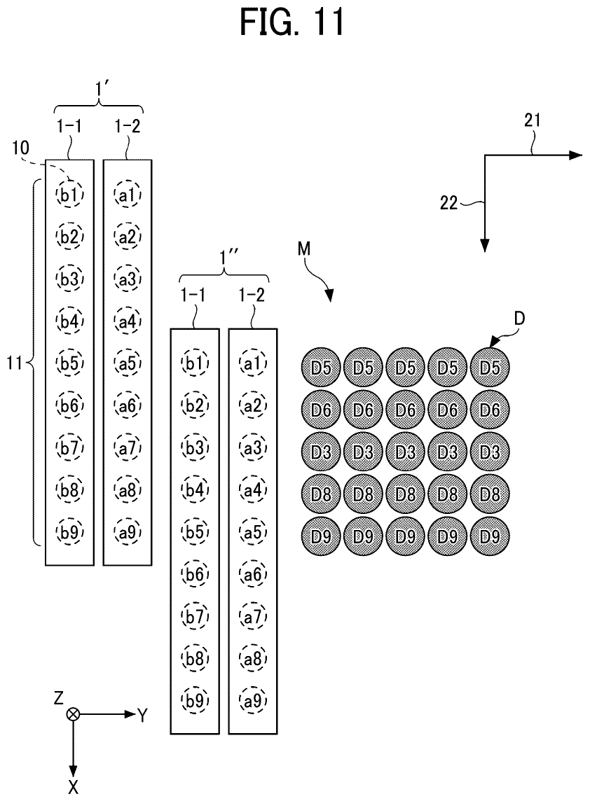

FIG. 11 is a diagram illustrating a complementation by a complementing nozzle of the liquid discharge apparatus 100a. In FIG. 11, a head 1′ represents the head 1 when the head 1 and the discharge target M perform a first relative movement in the main scanning direction 21. A head 1″ represents the head 1 when the head 1 and the discharge target M perform a second relative movement in the main scanning direction 21.

The first head 1-1 includes nine nozzles 10 including nozzles b1 to b9. The second head 1-2 includes nine nozzles 10 including nozzles a1 to a9. Dots D5 are formed by liquid discharged from the nozzle a5 of the head 1′ in the first relative movement. Dots D6 are formed by liquid discharged from the nozzle a6 of the head 1′ in the first relative movement. Dots D3 are formed by liquid discharged from the nozzle a3 of the head 1″ in the second relative movement. Dots D8 are formed by liquid discharged from the nozzle a8 of the head 1′ in the first relative movement. Dots D9 are formed by liquid discharged from the nozzle a9 of the head 1′ in the first relative movement.

The nozzle a7 is a nozzle to be complemented. The liquid discharge apparatus 100a does not discharge liquid from the nozzle a7 to an area corresponding to the nozzle a7. The liquid discharge apparatus 100a specifies the nozzle a3 or the nozzle b3 disposed upstream from the nozzle a7 in the sub-scanning direction 22 as the complementing nozzle. The liquid discharge apparatus 100a discharges liquid from the nozzle a3 or the nozzle b3 in the second relative movement to apply the liquid to the area corresponding to the nozzle a7 in the first relative movement. Thus, the nozzle a3 or the nozzle b3 can complement the nozzle a7.

The complementation by the nozzle a3 or the nozzle b3, which is the complementing nozzle, is not limited to the complementation performed in the second relative movement. For example, when n represents a natural number, the complementing nozzle may discharge liquid in the (n+1)th relative movement or subsequent relative movements to complement the area where the nozzle to be complemented does not discharge the liquid in the nth relative movement.

The nozzle a3 or the nozzle b3 illustrated in FIG. 11 is disposed upstream from the nozzle a7 in the sub-scanning direction 22. Accordingly, the liquid discharge apparatus 100a can discharge liquid to the area onto which the liquid is to be discharged by the nozzle a7 without moving the nozzle a3 or the nozzle b3 relative to the discharge target M for the purpose of complementation only.

Thus, the liquid discharge apparatus 100a uses the nozzle a3 or the nozzle b3 as a complementing nozzle to perform complementation during image formation without an extra relative movement for the purpose of complementation only. As a result, the liquid discharge apparatus 100a can perform complementation while preventing a decrease in producibility. In addition, in the serial-type liquid discharge apparatus 100a, a nozzle having a discharge failure can be complemented with high accuracy while preventing a decrease in productivity. The effects other than described above in the liquid discharge apparatus 100a are the same as the effects of the liquid discharge apparatus 100.

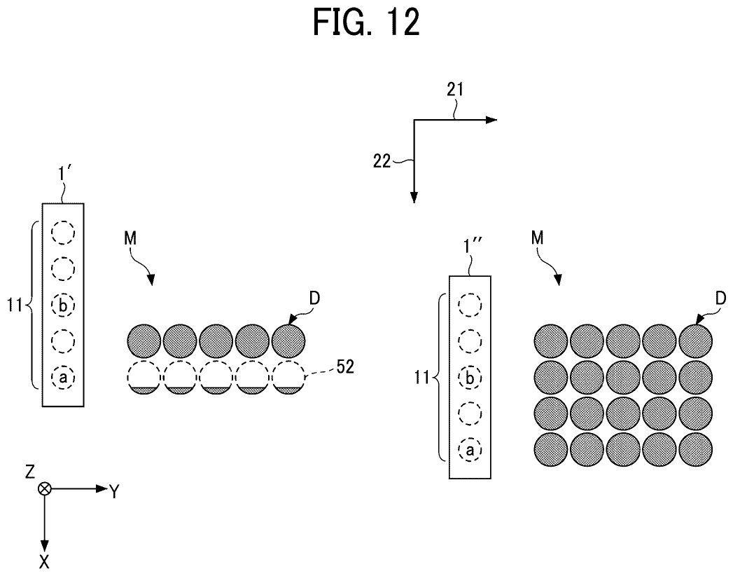

FIG. 12 is another diagram illustrating a nozzle to be complemented and a complementing nozzle of the liquid discharge apparatus 100a. The liquid discharge apparatus 100a illustrated in FIG. 12 is different from the liquid discharge apparatus 100a illustrated in FIG. 9 in that the head has only one nozzle array 11.

In FIG. 12, a head 1′ represents the head 1 when the head 1 and the discharge target M perform an nth relative movement in the main scanning direction 21. A head 1″ represents the head 1 when the head 1 and the discharge target M perform (n+1)th relative movement in the main scanning direction 21.

A complementing nozzle b is disposed upstream from a nozzle to be complemented a in the sub-scanning direction 22. As illustrated in the right side of FIG. 12, the complementing nozzle b can discharge liquid in the (n+1)th relative movement to complement the area where the nozzle to be complemented a does not discharge the liquid in the nth relative movement as illustrated in the left side of FIG. 12.

The liquid discharge apparatus 100a can select the timing of performing complementation according to the positional relationship between the nozzle to be complemented and the complementing nozzle. For example, when the complementing nozzle can discharge liquid onto the area onto which the liquid is not discharged by the nozzle to be complemented in one relative movement, the complementation by the complementing nozzle may be performed in the one relative movement. Alternatively, the complementing nozzle may complement the nozzle to be complemented in the subsequent relative movement to be performed after the relative movement in which liquid is to be discharged by the nozzle to be complemented. If there are multiple complementing nozzles that can discharge liquid onto the area onto which the liquid is not discharged by the nozzle to be complemented, the complementation can be performed by a suitable nozzle selected from the multiple complementing nozzles or the combination of some nozzles selected from the multiple complementing nozzles.

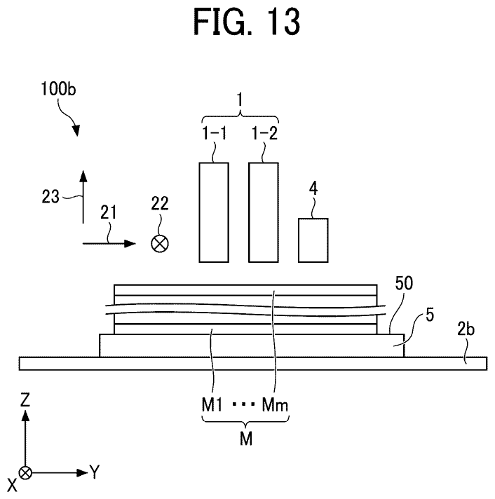

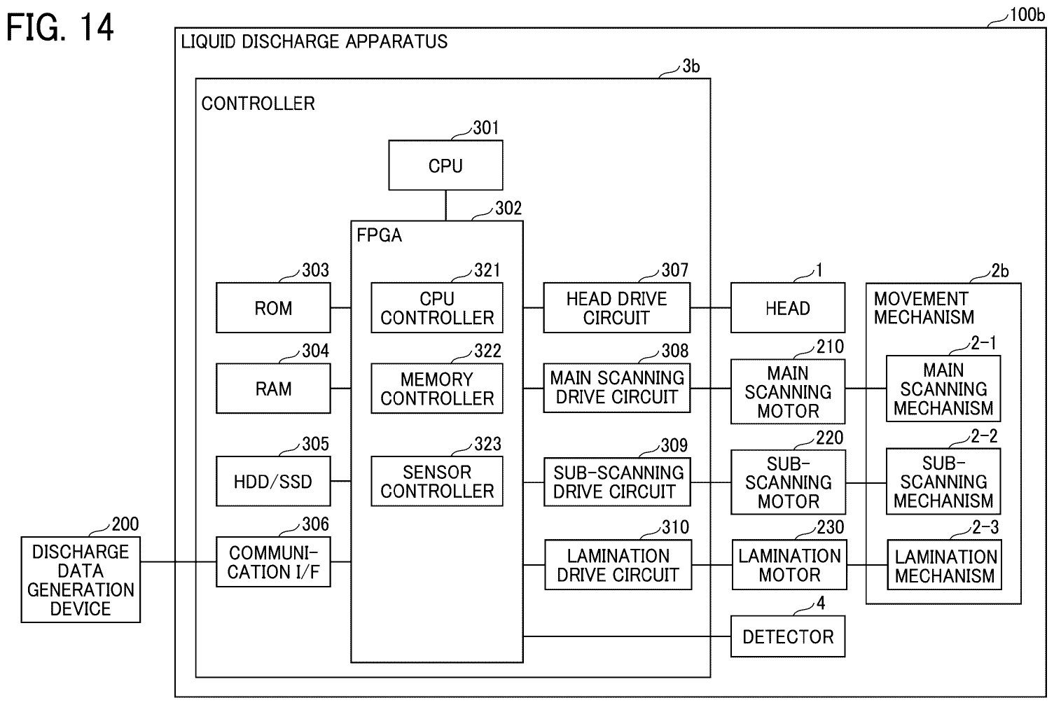

A liquid discharge apparatus 100b is described below. FIG. 13 is a schematic side view of the liquid discharge apparatus 100b. FIG. 14 is a block diagram illustrating a hardware configuration of the liquid discharge apparatus 100b.

The liquid discharge apparatus 100b is different from the liquid discharge apparatus 100a in that the liquid discharge apparatus 100b is a three-dimensional fabrication apparatus that laminates layers of liquid discharged from the head 1 to fabricate a three-dimensional object. The liquid discharge apparatus 100b is, for example, a so-called material jet type three-dimensional fabrication apparatus.

The liquid discharge apparatus 100b discharges liquid onto the discharge target M while moving the head 1 and the discharge target M relative to each other multiple times in each of the sub-scanning direction 22, which is the first direction X; the main scanning direction 21, which is the second direction Y; and the lamination direction 23, which is the third direction Z, by a movement mechanism 2b. The liquid discharge apparatus 100b laminates layers formed of the discharged liquid in the lamination direction 23 to form a three-dimensional object.

As illustrated in FIGS. 13 and 14, the liquid discharge apparatus 100b is different from the liquid discharge apparatus 100a in that the liquid discharge apparatus 100b includes the movement mechanism 2b, a controller 3b, a fabrication table 5, and a lamination motor 230. The movement mechanism 2b includes the main scanning mechanism 2-1, the sub-scanning mechanism 2-2, and a lamination mechanism 2-3. The controller 3b includes a lamination drive circuit 310.

The fabrication table 5 has a fabrication surface 50 on which layers of liquid is laminated to fabricate a three-dimensional object. In FIG. 13, liquid is discharged onto the fabrication surface 50 of the fabrication table 5 to form a first layer M1. Thus, the fabrication surface 50 serves as the discharge target M. Then, the liquid is discharged onto the first layer M1 to laminate a second layer on the first layer M1. Thus, the first layer M1 serves as the discharge target M. Lastly, the liquid is discharged onto the (m−1)th layer to laminate the mth layer Mm on the (m−1)th layer to complete the fabrication of the three-dimensional object. Since the discharge target M is defined as a target onto which liquid is discharged from the head 1, the discharge target M in the liquid discharge apparatus 100b includes the fabrication surface 50 and each of multiple layers of the three-dimensional object. The multiple layers are laminated layer by layer from the start of fabrication to the end of fabrication in a fabrication process to fabricate the three-dimensional object.

The lamination drive circuit 310 is an electric circuit that drives and rotates the lamination motor 230 to move the head 1 in the lamination direction 23 by the lamination mechanism 2-3. In a fabrication operation, the liquid discharge apparatus 100b receives slice data as the discharge data from the discharge data generation device 200. The slice data is obtained by slicing data of a three-dimensional object as a target to be fabricated into multiple layers. Then, the liquid discharge apparatus 100b moves the head 1 and the discharge target M relative to each other in each of the main scanning direction 21, the sub-scanning direction 22, and the lamination direction 23, and discharges liquid from the head 1 to fabricate the three-dimensional object. When the fabrication of the three-dimensional object is completed, the three-dimensional object is taken out from the fabrication table 5.

In the liquid discharge apparatus 100b, the procedure of detecting the location of the discharge failure, determining the complementing nozzle according to the location of the discharge failure, and performing the complementation is the same as the above-described procedure. However, for example, when the lamination is repeated as in the liquid discharge apparatus 100b which is the material jet type three-dimensional fabrication apparatus, since it takes long time to complete the fabrication of the three-dimensional object, the discharge failure may newly occur in the middle of the fabrication, and the state may be changed from the initial state at the time of the start of the fabrication. Accordingly, in the liquid discharge apparatus 100b, when the discharge failure is detected in the middle of the fabrication, the complementation scheduled at the start of the fabrication is preferably updated. Alternatively, the complementation is not scheduled at the start of the fabrication, the discharge failure is periodically detected, and the complementation is scheduled in response to each detection.

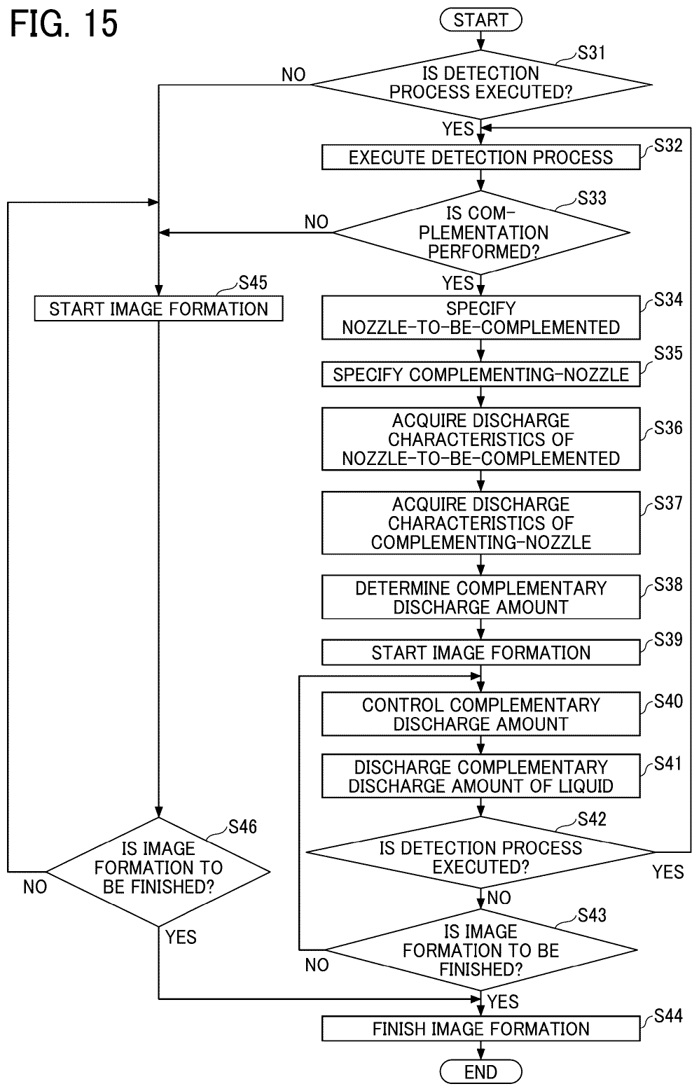

FIG. 15 is a flowchart of an operation of the liquid discharge apparatus 100b. FIG. 15 illustrates an operation of the liquid discharge apparatus 100b. In the liquid discharge apparatus 100b, the complementation is not scheduled at the start of the fabrication, the discharge failure is periodically detected, and the complementation is scheduled in response to each detection. The description of the same operation as that illustrated in FIG. 8 will be omitted as appropriate. In FIG. 15, the fabrication of each layer of the three-dimensional object by the material jet is expressed as “image formation.”

First, in step S31, the liquid discharge apparatus 100b determines whether to execute a detection process. For example, the liquid discharge apparatus 100b executes the detection process when a detection execution condition predetermined in a condition setting file of the fabrication of the three-dimensional object is satisfied.

In step S31, when the liquid discharge apparatus 100b determines that the detection process is to be executed (Yes in step S31), in step S32, the liquid discharge apparatus 100b executes the detection process.

Subsequently, in step S33, the liquid discharge apparatus 100b determines whether to perform complementation. For example, the liquid discharge apparatus 100b performs the complementation when a nozzle to be complemented is detected in the detection result in the detection process of step S32.

The operations from step S34 to step S39 are the same as the operations from step S11 to step S16 in FIG. 8. The operations of step S40 and step S41 are the same as the operations of step S18 and step S19 in FIG. 8.

In step S42, the liquid discharge apparatus 100b determines whether to execute the detection process. In step S42, when the liquid discharge apparatus 100b determines that the detection process is to be executed (Yes in step S42), the liquid discharge apparatus 100b performs the operation of step S32 and the subsequent operations again. On the other hand, when the liquid discharge apparatus 100b determines that the detection process is not to be executed (No in step S42), in step S43, the liquid discharge apparatus 100b determines whether to finish the image formation. For example, the liquid discharge apparatus 100b finishes the image formation when an end condition predetermined in the condition setting file of the fabrication of the three-dimensional object is satisfied.

In step S43, when the liquid discharge apparatus 100b determines that the image formation is not to be finished (No in step S43), the liquid discharge apparatus 100b performs the operation of step S40 and the subsequent operations again, and repeats the operations until the liquid discharge apparatus 100b determines, in step S43, that the image formation is to be finished. On the other hand, when the liquid discharge apparatus 100b determines that the image formation is to be finished (Yes in step S43), in step S44, the liquid discharge apparatus 100b finishes the image formation.

In step S31, when the liquid discharge apparatus 100b determines that the detection step is not executed (No in step S31), in step S45, the liquid discharge apparatus 100b starts the image formation. In step S46, the liquid discharge apparatus 100b determines whether to finish the image formation. In step S46, when the liquid discharge apparatus 100b determines that the image formation is not to be finished (No in step S46), the liquid discharge apparatus 100b performs the operation of step S45 again, and repeats the operations until the liquid discharge apparatus 100b determines, in step S46, that the image formation is to be finished. On the other hand, when the liquid discharge apparatus 100b determines that the image formation is to be finished (Yes in step S46), in step S44, the liquid discharge apparatus 100b finishes the image formation.

As described above, the liquid discharge apparatus 100b can fabricates a three-dimensional object.

In the liquid discharge apparatus 100b, the complementation can be performed not in a layer to which liquid is to be discharged by the nozzle to be complemented but when forming the next layer or the subsequent layers (layers overlapping over the layer to which liquid is to be discharged by the nozzle to be complemented). However, if the layer to which liquid is to be discharged by the nozzle to be complemented and the layer in which the complementation is performed are away from each other, the effect of the complementation is reduced, and thus the complementation is preferably performed within three layers.

Although the embodiments have been described above, the present disclosure is not limited to the embodiment specifically described above, and components of the embodiments include components that may be easily conceived by those skilled in the art, components being substantially the same, and components being within equivalent ranges. Furthermore, various omissions, substitutions, changes, and combinations of the components can be made without departing from the gist of the above-described embodiments.

A liquid discharge apparatus according to an embodiment of the present disclosure is not limited to a monochrome printer. For example, a liquid discharge apparatus according to an embodiment of the present disclosure may be a color printer that includes multiple heads 1 to discharge liquids of different colors to form a color image.

The numbers such as ordinal number and quantity used in the above description are all illustrative for the purpose of describing the technology of the embodiments of the present disclosure, and the embodiments of the present disclosure are not limited to the illustrative numbers. In addition, the above-describe connections among the components are examples for specifically describing the technology of the present disclosure, and connections for implementing functions of the present disclosure are not limited to the above-described examples.

Each function of the embodiments described above can be implemented by one processing circuit or a plurality of processing circuits. The term “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

Aspects of the present disclosure are, for example, as follows.

### Aspect 1

A liquid discharge apparatus includes a head, a movement mechanism, and a controller. The head has multiple nozzles. Each of the multiple nozzles discharges a liquid to a discharge target. The movement mechanism moves the head and the discharge target relative to each other. The controller controls discharge of the liquid by the head and relative movement by the movement mechanism based on discharge data related to the discharge of the liquid. The controller includes a complementing-nozzle specification unit and a determination unit. The complementing-nozzle specification unit specifies a complementing nozzle among the multiple nozzles. The complementing nozzle relatively moves to an area on the discharge target to which the liquid is to be discharged by a nozzle to be complemented, and discharges the liquid onto the area based on the discharge data. A discharge failure occurs in the nozzle to be complemented. The determination unit determines a complementary discharge amount by the complementing nozzle that complements the nozzle to be complemented based on data related to discharge characteristics of the multiple nozzles.

In other word, a liquid discharge apparatus includes a head, a movement mechanism, and circuitry. The head has multiple nozzles to discharge a liquid onto a discharge target in a discharge direction based on discharge data. The movement mechanism moves the head and the discharge target relative to each other in a main scanning direction intersecting the discharge direction. The circuitry controls the head and the movement mechanism to move the head and the discharge target relative to each other and discharge the liquid based on the discharge data, specifies a defective nozzle having a discharge failure among the multiple nozzles, specifies a planned area in the discharge target onto which the liquid is to be discharged from the defective nozzle, specifies a complementing nozzle among the multiple nozzles to discharge the liquid onto the planned area, determines a discharge amount of the liquid to be discharged from the complementing nozzle to the planned area based on data related to discharge characteristics of the multiple nozzles, and moves the head and the discharge target relative to each other and controls the head to discharge the liquid of the discharge amount from the complementing nozzle onto the planned area based on the discharge data.

### Aspect 2

In the liquid discharge apparatus according to Aspect 1, the data related to the discharge characteristics of the nozzles is predetermined data indicating a relationship between the multiple nozzles and a unit discharge volume which is a volume of the liquid per discharge in response to application of a unit drive voltage.

In other word, the circuitry applies drive voltage to the head to discharge the liquid from the multiple nozzles and determines the discharge amount based on predetermined data indicating a relationship between the multiple nozzles and a unit discharge volume that is a volume of the liquid per discharge in response to an application of a unit drive voltage as the data related to the discharge characteristics of the multiple nozzles.

Aspect 3 In the liquid discharge apparatus according to Aspect 1 or 2, the determination unit determines the complementary discharge amount so that a total volume of the liquid to be discharged from the nozzle to be complemented and a total volume of the liquid to be discharged from the complementing nozzle are equal to each other in a period in which one relative movement in the main scanning direction is performed.

In other word, the circuitry determines the discharge amount to equalize a first total volume of the liquid to be discharged from the defective nozzle and a second total volume of the liquid to be discharged from the complementing nozzle in one relative movement of the head and the discharge target in the main scanning direction.

### Aspect 4

In the liquid discharge apparatus according to any one of Aspects 1 to 3, the data related to the discharge characteristics of the multiple nozzles includes driving state data in which a relationship between at least one of a continuous driving state of a nozzle that performs discharge or a vicinity driving state of a nozzle positioned in the vicinity of the nozzle that performs discharge, and a discharge amount of the nozzle that performs discharge is determined in advance.

In other word, the circuitry determines the discharge amount based on driving state data that predefines a relationship between at least one of a continuous driving state of a discharge nozzle of the multiple nozzles that discharges the liquid or a vicinity driving state of an adjacent nozzle adjacent to the discharge nozzle, and a discharge amount of the discharge nozzle as the data related to the discharge characteristics of the multiple nozzles.

### Aspect 5

The liquid discharge apparatus according to any one of Aspects 1 to 4, further includes a discharge controller that controls discharge of the liquid by the head. The discharge controller controls at least one of a drive voltage applied to the head or the number of liquid droplets discharged from the complementing nozzle per unit time so that the complementing nozzle discharges the liquid of the complementary discharge amount determined by the determination unit.

In other word, the circuitry applies drive voltage to the head to discharge the liquid from the multiple nozzles and controls at least one of the drive voltage or a number of droplets of the liquid to be discharged from the complementing nozzle per unit time to discharge the liquid of the discharge amount from the complementing nozzle.

### Aspect 6

In the liquid discharge apparatus according to any one of Aspects 1 to 5, the head has the multiple nozzles arranged in a first direction, and the movement mechanism moves the head and the discharge target relative to each other only in a second direction orthogonal to the first direction.

In other word, the head has the multiple nozzles arrayed in a sub-scanning direction intersecting the discharge direction and orthogonal to the main scanning direction. The movement mechanism moves the head and the discharge target relative to each other in the main scanning direction.

### Aspect 7

In the liquid discharge apparatus according to any one of Aspects 1 to 5, the head has the multiple nozzles arranged in a first direction, and the movement mechanism moves the head and the discharge target relative to each other in each of the first direction and a second direction orthogonal to the first direction.

In other word, the head has the multiple nozzles arrayed in a sub-scanning direction intersecting the discharge direction and orthogonal to the main scanning direction. The movement mechanism moves the head and the discharge target relative to each other in each of the main scanning direction and the sub-scanning direction.

### Aspect 8

In the liquid discharge apparatus according to Aspect 6 or 7, the head has multiple nozzle arrays each including the multiple nozzles arranged in a first direction. The multiple nozzle arrays are arranged in a second direction orthogonal to the first direction, and the movement mechanism moves the head and the discharge target relative to each other in a main scanning direction along the second direction. The complementing nozzle is located upstream of the nozzle to be complemented in the main scanning direction.

In other word, the head has multiple nozzle arrays each including the multiple nozzles arrayed in the sub-scanning direction. The multiple nozzle arrays are arrayed in the main scanning direction. The movement mechanism moves the head and the discharge target relative to each other in the main scanning direction. The complementing nozzle is disposed upstream from the defective nozzle in the main scanning direction.

### Aspect 9

In the liquid discharge apparatus according to Aspect 7, the head has the multiple nozzles arranged in a first direction, and the movement mechanism moves the head and the discharge target relative to each other in each of a sub-scanning direction along the first direction and a second direction orthogonal to the first direction. The complementing nozzle is located upstream of the nozzle to be complemented in the sub-scanning direction.

In other word, the complementing nozzle is disposed upstream from the defective nozzle in the sub-scanning direction.

### Aspect 10

The liquid discharge apparatus according to any one of Aspects 1 to 9, further includes a detector that detects a discharge state of the multiple nozzles. The controller includes a nozzle-to-be-complemented specification unit that specifies the nozzle to be complemented having a discharge failure based on the discharge state of the multiple nozzles detected by the detector.

In other word, the liquid discharge apparatus according to any one of Aspects 1 to 9, further includes a detector to detect a discharge state of the multiple nozzles. The circuitry specifies the defective nozzle having the discharge failure based on the discharge state of the multiple nozzles detected by the detector.

### Aspect 11

In the liquid discharge apparatus according to any one of Aspects 1 to 10, the liquid discharge apparatus is a three-dimensional fabrication apparatus.

In other word, the liquid discharge apparatus is a three-dimensional fabrication apparatus to form a three-dimensional object.

### Aspect 12

In a liquid discharge method by a liquid discharge apparatus, the liquid discharge apparatus discharges a liquid by a head having multiple nozzles, each of which discharges the liquid to a discharge target, a movement mechanism moves the head and the discharge target relative to each other, and a controller controls discharge of the liquid by the head and relative movement by the movement mechanism based on discharge data related to the discharge of the liquid. The controller causes a complementing-nozzle specification unit to specify a complementing nozzle that can moves relative to the discharge target based on the discharge data and can discharge the liquid to an area on the discharge target to which the liquid is to be discharged by a nozzle to be complemented having a discharge failure among the multiple nozzles based on the discharge data, and causes a determination unit to determine a complementary discharge amount by the complementing nozzle that complements the nozzle to be complemented based on data related to discharge characteristics of the multiple nozzles.

In other word, a liquid discharge method includes discharging a liquid onto a discharge target from multiple nozzles of a head in a discharge direction based on discharge data, moving the head and the discharge target relative to each other in a main scanning direction intersecting the discharge direction, controlling the head and a movement mechanism to move the head and the discharge target relative to each other and discharge the liquid based on the discharge data, specifying a defective nozzle having a discharge failure among the multiple nozzles, specifying a planned area in the discharge target onto which the liquid is to be discharged from the defective nozzle, specifying a complementing nozzle among the multiple nozzles to discharge the liquid onto the planned area, determining a discharge amount of the liquid to be discharged from the complementing nozzle to the planned area based on data related to discharge characteristics of the multiple nozzles, and moving the head and the discharge target relative to each other and controlling the head to discharge the liquid of the discharge amount from the complementing nozzle onto the planned area based on the discharge data.

### Aspect 13

A program causes a liquid discharge apparatus to execute processing of discharging a liquid by a head including multiple nozzles each of which discharges the liquid to a discharge target, moving the head and the discharge target relative to each other by a movement mechanism, controlling discharge of the liquid by the head and relative movement by the movement mechanism based on discharge data related to the discharge of the liquid by a controller, causing the controller to specify a complementing nozzle that can moves relative to the discharge target based on the discharge data and can discharge the liquid to an area on the discharge target to which the liquid is to be discharged by a nozzle to be complemented having a discharge failure among the multiple nozzles by a complementing-nozzle specification unit based on discharge data, and causing the controller to determine a complementary discharge amount by the complementing nozzle that complements the nozzle to be complemented based on data related to discharge characteristics of the multiple nozzles by a determination unit.

In other word, a non-transitory storage medium stores a plurality of instructions which, when executed by one or more processors, causes the processors to perform a method. The method includes discharging a liquid onto a discharge target from multiple nozzles of a head in a discharge direction based on discharge data, moving the head and the discharge target relative to each other in a main scanning direction intersecting the discharge direction, controlling the head and a movement mechanism to move the head and the discharge target relative to each other and discharge the liquid based on the discharge data, specifying a defective nozzle having a discharge failure among the multiple nozzles, specifying a planned area in the discharge target onto which the liquid is to be discharged from the defective nozzle, specifying a complementing nozzle among the multiple nozzles to discharge the liquid onto the planned area, determining a discharge amount of the liquid to be discharged from the complementing nozzle to the planned area based on data related to discharge characteristics of the multiple nozzles, and moving the head and the discharge target relative to each other and controlling the head to discharge the liquid of the discharge amount from the complementing nozzle onto the planned area based on the discharge data.

As described above, according to one aspect of the present disclosure, a nozzle having a discharge failure can be complemented with high accuracy while preventing a decrease in productivity.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a head having multiple nozzles to discharge a liquid onto a discharge target in a discharge direction based on discharge data;
a movement mechanism to move the head and the discharge target relative to each other in a main scanning direction intersecting the discharge direction; and
circuitry configured to:
control the head and the movement mechanism to move the head and the discharge target relative to each other and discharge the liquid based on the discharge data;
specify a defective nozzle having a discharge failure among the multiple nozzles;
specify a planned area in the discharge target onto which the liquid is to be discharged from the defective nozzle;
specify a complementing nozzle among the multiple nozzles to discharge the liquid onto the planned area;
determine a discharge amount of the liquid to be discharged from the complementing nozzle to the planned area based on data related to discharge characteristics of the multiple nozzles; and
move the head and the discharge target relative to each other and control the head to discharge the liquid of the discharge amount from the complementing nozzle onto the planned area based on the discharge data.

2. The liquid discharge apparatus according to claim 1,
wherein the circuitry is further configured to:
apply drive voltage to the head to discharge the liquid from the multiple nozzles; and
determine the discharge amount based on predetermined data indicating a relationship between:
the multiple nozzles; and
a unit discharge volume that is a volume of the liquid per discharge in response to an application of a unit drive voltage as the data related to the discharge characteristics of the multiple nozzles.

3. The liquid discharge apparatus according to claim 1,
wherein the circuitry is further configured to determine the discharge amount to equalize:
a first total volume of the liquid to be discharged from the defective nozzle; and
a second total volume of the liquid to be discharged from the complementing nozzle,
in one relative movement of the head and the discharge target in the main scanning direction.

4. The liquid discharge apparatus according to claim 1,
wherein the circuitry is further configured to determine the discharge amount based on driving state data that predefines a relationship between:
at least one of:
a continuous driving state of a discharge nozzle of the multiple nozzles that discharges the liquid; or
a vicinity driving state of an adjacent nozzle adjacent to the discharge nozzle; and
a discharge amount of the discharge nozzle,
as the data related to the discharge characteristics of the multiple nozzles.

5. The liquid discharge apparatus according to claim 1,
wherein the circuitry is further configured to:
apply drive voltage to the head to discharge the liquid from the multiple nozzles; and
control at least one of:
the drive voltage; or
a number of droplets of the liquid to be discharged from the complementing nozzle per unit time,
to discharge the liquid of the discharge amount from the complementing nozzle.

6. The liquid discharge apparatus according to claim 1,
wherein the head has the multiple nozzles arrayed in a sub-scanning direction intersecting the discharge direction and orthogonal to the main scanning direction, and
the movement mechanism moves the head and the discharge target relative to each other in the main scanning direction.

7. The liquid discharge apparatus according to claim 1,
wherein the head has the multiple nozzles arrayed in a sub-scanning direction intersecting the discharge direction and orthogonal to the main scanning direction, and
the movement mechanism moves the head and the discharge target relative to each other in each of the main scanning direction and the sub-scanning direction.

8. The liquid discharge apparatus according to claim 6,
wherein the head has multiple nozzle arrays each including the multiple nozzles arrayed in the sub-scanning direction,
the multiple nozzle arrays are arrayed in the main scanning direction,
the movement mechanism moves the head and the discharge target relative to each other in the main scanning direction, and
the complementing nozzle is disposed upstream from the defective nozzle in the main scanning direction.

9. The liquid discharge apparatus according to claim 7,
wherein the complementing nozzle is disposed upstream from the defective nozzle in the sub-scanning direction.

10. The liquid discharge apparatus according to claim 1, further comprising:
a detector to detect a discharge state of the multiple nozzles,
wherein the circuitry is further configured to specify the defective nozzle having the discharge failure based on the discharge state of the multiple nozzles detected by the detector.

11. The liquid discharge apparatus according to claim 1,
wherein the liquid discharge apparatus is a three-dimensional fabrication apparatus to form a three-dimensional object.

12. A liquid discharge method comprising:
discharging a liquid onto a discharge target from multiple nozzles of a head in a discharge direction based on discharge data;
moving the head and the discharge target relative to each other in a main scanning direction intersecting the discharge direction;
controlling the head and a movement mechanism to move the head and the discharge target relative to each other and discharge the liquid based on the discharge data;
specifying a defective nozzle having a discharge failure among the multiple nozzles;
specifying a planned area in the discharge target onto which the liquid is to be discharged from the defective nozzle;
specifying a complementing nozzle among the multiple nozzles to discharge the liquid onto the planned area;
determining a discharge amount of the liquid to be discharged from the complementing nozzle to the planned area based on data related to discharge characteristics of the multiple nozzles; and
moving the head and the discharge target relative to each other and controlling the head to discharge the liquid of the discharge amount from the complementing nozzle onto the planned area based on the discharge data.

13. A non-transitory storage medium storing a plurality of instructions which, when executed by one or more processors, causes the processors to perform a method, comprising:
discharging a liquid onto a discharge target from multiple nozzles of a head in a discharge direction based on discharge data;
moving the head and the discharge target relative to each other in a main scanning direction intersecting the discharge direction;
controlling the head and a movement mechanism to move the head and the discharge target relative to each other and discharge the liquid based on the discharge data;
specifying a defective nozzle having a discharge failure among the multiple nozzles;
specifying a planned area in the discharge target onto which the liquid is to be discharged from the defective nozzle;
specifying a complementing nozzle among the multiple nozzles to discharge the liquid onto the planned area;
determining a discharge amount of the liquid to be discharged from the complementing nozzle to the planned area based on data related to discharge characteristics of the multiple nozzles; and
moving the head and the discharge target relative to each other and controlling the head to discharge the liquid of the discharge amount from the complementing nozzle onto the planned area based on the discharge data.
